(19) United States
(12) Patent Application Publication
(10) Pub. No.: US 2023/0336634 A1
(43) Pub. Date: Oct. 19, 2023

(54) SERVER DEVICE, PROGRAM, METHOD, AND TERMINAL DEVICE

(71) Applicant: BEATRUST, INC., Minato Ku, Tokyo (JP)

(72) Inventors: Kunio HARA, Minato (JP); Masato KUME, Minato (JP); Ryo NAGAOKA, Minato (JP)

(21) Appl. No.: 18/025,522

(22) PCT Filed: Sep. 10, 2020
(86) PCT No.: PCT/JP2020/034355

§ 371 Date: May 8, 2023

(51) Int. Cl. G06Q 50/00; H04L 67/50

(52) U.S. Cl. CPC H04L 67/50; G06Q 50/01

(57) ABSTRACT

A server device includes: a communication interface; a memory configured to store the computer readable instructions and tag information assigned to a first user in association with user ID information about the first user owning a first terminal device; and a processor which is configured to receive, through the communication interface, source information in a free text related to the first user from at least one among one or a plurality of information storage devices on the basis of a predetermined instruction command stored in the memory, extract the tag information which may be assigned to the first user from the received source information, and perform processing for enabling the extracted tag information to be associated with the identification information of the first user and to be stored in the memory.

### TECHNICAL FIELD

The present disclosure relates to a server device, a program, a method, and a terminal device for exchanging various kinds of information among terminal devices owned by respective users.

### BACKGROUND ART

Conventionally, there has been known a social networking service (SNS) for exchanging a message between a certain user and another user who is in a friend relationship with the certain user via a network, or for allowing the certain user to transmit various kinds of information to another user or an unspecified number of users. For example, Patent Literature 1 describes a personal information management system in which enables application for, establishment of, etc. a friend relationship only with an appropriate partner, and determines whether or not a user is actually an appropriate partner with reference to a telephone directory of each user.

### CITATION LIST

### Patent Literature

Patent Literature 1: JP 2011-081670 A

### Technical Problem

Accordingly, in light of the above-described technique, the present disclosure provides a server device, a program, a method, and a terminal device which can provide a service more convenient for a user to use.

### SUMMARY

According to one aspect of the present disclosure, there is provided a server device including: a communication interface configured to transmit and receive predetermined information via a network to and from one or more information storage devices and a plurality of terminal devices including a first terminal device; a memory configured to store tag information assigned to a first user in association with user ID information of the first user owning the first terminal device in addition to a prescribed instruction command; and a processor configured to perform, based on the prescribed instruction command stored in the memory, processes for: receiving, via the communication interface, source information in a free text related to the first user, from at least one among the one or more information storage devices, extracting tag information which may be assigned to the first user from the received source information, and enabling the extracted tag information to be associated with the identification information of the first user and to be stored in the memory”.

According to one aspect of the present disclosure, there is provided a program that causes a computer including a communication interface configured to transmit and receive predetermined information to and from one or more information storage devices and a plurality of terminal devices including a first terminal device via a network, and a memory configured to store tag information assigned to a first user in association with user ID information of the first user owning the first terminal device, to function as a processor configured to: receive, via the communication interface, source information in a free text related to the first user from at least one among the one or more information storage devices, extract tag information which can be assigned to the first user from the received source information, and enable the extracted tag information to be associated with the identification information of the first user and to be stored in the memory.

According to one aspect of the present disclosure, there is provided a method performed by a processor executing a prescribed instruction command in a computer including a communication interface configured to transmit and receive predetermined information to and from one or more information storage devices and a plurality of terminal devices including a first terminal device via a network, and a memory configured to store tag information assigned to a first user in association with user ID information of the first user owning the first terminal device in addition to the prescribed instruction command, the method including the steps of: receiving, via the communication interface, source information in a free text related to the first user, from at least one among the one or more information storage devices; extracting tag information which may be assigned to the first user from the received source information; and enabling the extracted tag information to be associated with the identification information of the first user and to be stored in the memory.

According to one aspect of the present disclosure, there is provided a terminal device including: a communication interface configured to transmit and receive predetermined information via a network to and from a server device communicably connected to one or more information storage devices; a memory configured to store tag information assigned to a user in association with identification information of the user in addition to a prescribed instruction command; an input interface configured to receive an instruction input from the user; and a processor configured to perform, based on the prescribed instruction command, processes for receiving, via the communication interface, tag information extracted in the server device which has received source information in a free text related to the user from at least one among the one or more information storage devices as tag information that may be assigned to the user, and storing the received tag information in the memory.

### Advantageous Effects of Invention

The present disclosure can provide a server device, a program, a method, and a terminal device which can provide a service more convenient for a user to use.

It should be noted that the above-described effects are merely examples for convenience of description and are not restrictive. In addition to or instead of the above-described effects, any effect described in the present disclosure or an effect apparent to those skilled in the art may be provided.

### BRIEF DESCRIPTION OF THE DRAWINGS

FIG. 1 is a conceptual diagram schematically illustrating the configuration of a system 1 according to the present disclosure.

FIG. 2 is a block diagram illustrating an example of the configuration of a server device 100 according to the present disclosure.

FIG. 3 is a block diagram illustrating an example of the configuration of a terminal device 300 according to the present disclosure.

FIG. 4A is a diagram conceptually illustrating a user information table stored in the server device 100 according to the present disclosure.

FIG. 4B is a diagram conceptually illustrating a personnel evaluation information table stored in an information storage device 200 according to the present disclosure.

FIG. 4C is a diagram conceptually illustrating a message information table stored in the information storage device 200 according to the present disclosure.

FIG. 4D is a diagram conceptually illustrating a candidate tag information table stored in the server device 100 according to the present disclosure.

FIG. 4E is a diagram conceptually illustrating a personnel evaluation information stored in the information storage device 200 according to the present disclosure.

FIG. 5 is a diagram illustrating a processing sequence executed in the system 1 according to the present disclosure.

FIG. 6 is a diagram illustrating a processing flow executed in the server device 100 according to the present disclosure.

FIG. 7 is a diagram illustrating a processing flow executed in the terminal device 300 according to the present disclosure.

FIG. 8 is a diagram illustrating a processing flow executed in the terminal device 300 according to the present disclosure.

FIG. 9 is a diagram illustrating an example of a screen displayed on the terminal device 300 according to the present disclosure.

FIG. 10 is a diagram illustrating an example of a screen displayed on the terminal device 300 according to the present disclosure.

FIG. 11 is a diagram illustrating an example of a screen displayed on the terminal device 300 according to the present disclosure.

FIG. 12 is a diagram illustrating an example of a screen displayed on the terminal device 300 according to the present disclosure.

FIG. 13 is a diagram illustrating an example of a screen displayed on the terminal device 300 according to the present disclosure.

FIG. 14 is a diagram illustrating an example of a screen displayed on the terminal device 300 according to the present disclosure.

### DETAILED DESCRIPTION

Various embodiments of the present disclosure will be described with reference to the accompanying drawings. Common components in the diagrams are provided with the same reference signs.

### 1. Overview of System According to the Present Disclosure

The system according to the present disclosure essentially includes a server device, a terminal device owned by a user, and an information storage device communicably connected to the server device. As an example, the system is used for a networking service that enables a plurality of users to exchange messages, to browse not only profile information of a local user but also profile information of other users to establish a specific relation with the other users via a network, and/or to browse various information transmitted by the other users, etc.

Here, in the case that other profile information includes items that other users are good at, items indicating preferences of other users, items indicating characters of other users, and the like, the information is useful when searching for other users or when understanding other users at the time of browsing. Therefore, the system according to the present disclosure enables storage of keyword information assigned as information related to each user, that is, tag information as profile information of each user. In addition, in the system according to the present disclosure makes it possible to reflect evaluation of the user himself or herself from other users as tag information by automatically extracting such tag information from various source information associated with each user (for example, information in a free text form such as personnel evaluation information of each user and message information transmitted and received by each user). For example, more specific and highly confidential tag information can be assigned to each user by using source information, etc. that can be accessed only within an organization to which each user belongs instead of source information that can be easily accessed by an unspecified number of users.

Note that, according to the present disclosure, “tag information” refers to keyword information stored as information related to a user as described above, and is not limited to only information having a specific meaning, such as an item the user is good at or an item indicating a preference. Tag information may be composed straightforwardly of one word or a combination of a plurality of words, such as “intellectual property” and “sweet lover”, and tag information may also be composed in a sentence form, such as “strong in patents”.

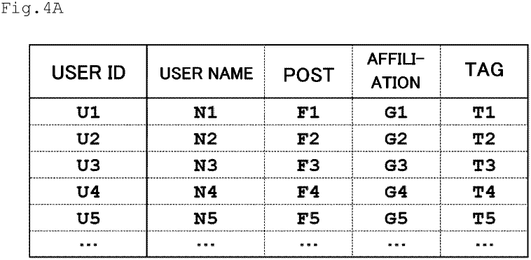

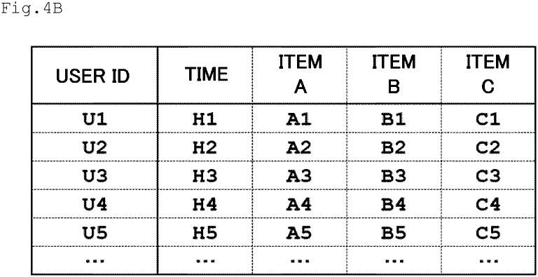

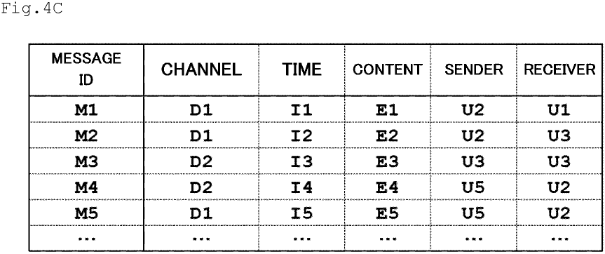

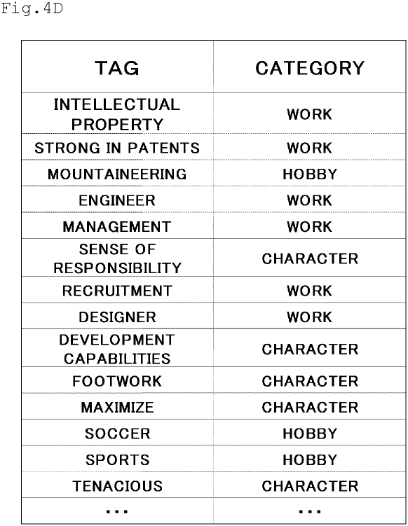

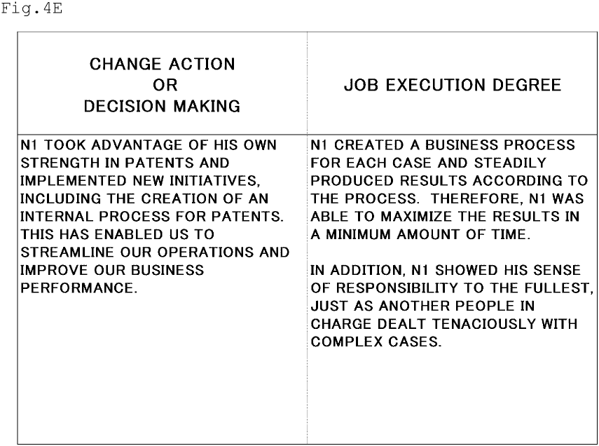

In addition, according to the present disclosure, tag information may typically be automatically extracted from source information which is in a free text form, but this “source information in a free text form” is not input in a predetermined expression form for extracting tag information only for the purpose of extracting tag information, but merely means source information input for other purposes or uses. Typically, information such as personnel evaluation information (for example, FIG. 4E) or message information, which is input in a prose form such as a conversation or a sentence, is used as the source information.

In addition, according to the present disclosure, the source information is stored in the information storage device. Such an information storage device may be configured separately from the server device, or may be configured integral with the server device, and should not necessarily be configured merely to store information. The information storage device is preferably a device access to which by an unspecified number of users is restricted. Typical examples thereof include devices that can be accessed only by specific users permitted by an organization to which certain users belong, including a device storing personnel evaluation information of a company, a server device for a chat or message service for employees, a server device for business management of a company, a server device for sharing development information within a company, etc. Specific examples of the source information stored in such an information storage device include personnel evaluation information and message information as described above, and in addition, include internal documents such as design documents and minutes, and SNS data of a subject.

In addition, according to the present disclosure, “first user” and “second user”, and “first terminal device” and “second terminal device” are merely use “first” and “second”, respectively, in order to distinguish each user and each terminal device from another user and another terminal device. That is, when a user has once been a first user, that user may also become a second user when a certain process is performed (and vice versa). In addition, when a terminal device has once been a first terminal device, that terminal device may also become a second terminal device when a certain process or function is performed (and vice versa).

### 2. Configuration of System 1 According to the Present Disclosure

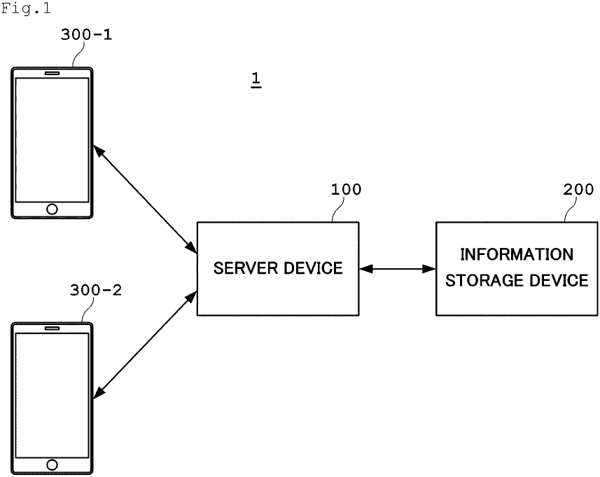

FIG. 1 is a conceptual diagram schematically illustrating the configuration of a system 1 according to the present disclosure. With reference to FIG. 1, the system 1 includes a server device 100, an information storage device 200, and a plurality of terminal devices 300 (terminal device 300-1, terminal device 300-2, etc.). The server device 100 is communicably connected to each device via a network.

According to the present disclosure, the information storage device 200 and the terminal device 300 need not be connected together so as to be directly communicatable with each other. In addition, although only one or two information storage devices 200 or terminal devices 300 are described, two terminal devices or three or more terminal devices may naturally be included. In addition, although the server device 100 is described as a single device, it is also possible to distribute the individual components and processes to a plurality of server devices or connect them to various databases.

### 3. Configuration of Server Device 100

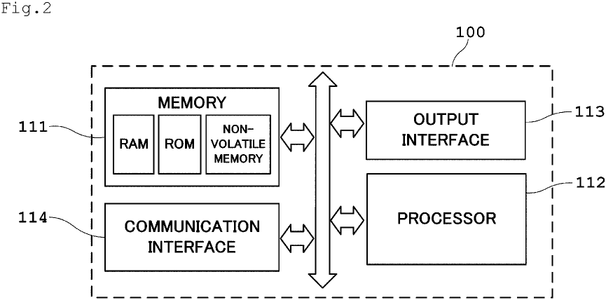

FIG. 2 is a block diagram illustrating an example of the configuration of the server device 100 according to the present disclosure. The server device 100 need not include all of the components illustrated in FIG. 2, and may have a configuration in which a part of the components is omitted, or may additionally be provided with other components.

With reference to FIG. 2, the server device 100 includes a memory 111 including a RAM, a ROM, a nonvolatile memory, an HDD, a processor 112 comprised of a CPU, etc., an output interface 113, and a communication interface 114. These components are electrically connected to one another via a control line and data lines. The memory 111 may also include a database connected via a communication interface, etc.

The memory 111 includes the RAM, the ROM, the nonvolatile memory, and the HDD, and functions as a storage unit. The memory 111 stores an instruction command, as a program, for executing an application or an OS according to the present disclosure. Such a program is loaded and executed by the processor 112. The memory 111 also stores a user information table (FIG. 4A) and a candidate tag information table (FIG. 4D). In addition, the memory 111 (in particular, RAM) is temporarily used to execute data writing and reading while the program is being executed by the processor 112. According to the present disclosure, the memory 111 particularly stores programs for executing a process of receiving source information in a free text related to each user from the information storage device 200 via the communication interface 114, a process of extracting tag information that may be assigned to each user from the received source information, a process of enabling the extracted tag information to be stored in the memory 111 in association with identification information of each user, a process of extracting tag information by comparing each candidate tag information stored in the candidate tag information table with the source information, and a process of extracting tag information by performing morpheme analysis on the source information, etc.

The processor 112 includes a CPU (microcomputer) and functions as a control unit for controlling other connected components based on various programs stored in the memory 111. According to the present disclosure, particularly, the processor 112 executes the process of receiving source information in a free text related to each user from the information storage device 200 via the communication interface 114, the process of extracting tag information that may be assigned to each user from the received source information, the process of enabling the extracted tag information to be stored in the memory 111 in association with identification information of each user, the process of extracting tag information by comparing each candidate tag information stored in the candidate tag information table with the source information, the process of extracting tag information by performing morpheme analysis on the source information, and the like. The processor 112 may be comprised of a single CPU or may be comprised of a plurality of CPUs.

As an example, the communication interface 114 functions as a communication unit that performs processes such as modulation and demodulation in order to transmit and receive, via a network, a program, various types of information, and the like used in the system 1 according to the present fire to and from the information storage device 200, the terminal device 300, and/or other server devices. The communication interface 114 communicates with the information storage device 200, the terminal device 300, and/or other server devices in accordance with the above-described wireless communication method or a known wired communication method. According to the present disclosure, source information is received from the information storage device 200 via the communication interface 114. In addition, via the communication interface 114, recommended tag information and the like are transmitted to the terminal device 300, and selected tag information, additional tag information, and the like are received from the terminal device 300.

Although not particularly illustrated, the output interface 113 functions as an information input and output unit for inputting and outputting information to and from various external devices such as a printer and a display. The output interface 113 can adopt a known connection form such as a serial port, a parallel port, or a USB as desired.

### 4. Configuration of Information Storage Device 200

Although a specific configuration of the information storage device 200 is not particularly illustrated, the information storage device 200 includes at least a memory and a communication interface. As an example, information such as a personnel evaluation information table (FIG. 4B) and a message information table (FIG. 4C) is stored in the information storage device 200. Then, necessary information from among the stored information is transmitted to the server device 100 via the communication interface in response to a request transmitted from the server device 100.

Although the information storage device 200 is illustrated as a single unit in FIG. 1, the system 1 may naturally include a plurality of information storage devices 200. In addition, access to the information storage device 200 is restricted by methods such as prior user registration and user authentication, and free access to the information storage device 200 by an unspecified number of users is restricted. As an example, an access right may be granted in advance to only a specific user permitted by an administrator of the organization to which a certain user belongs, and access may be restricted by requesting authentication using a password corresponding to the granted access right every time the user accesses. Further, access may be restricted by managing the information storage device 200 under an environment physically or virtually isolated from a network to which an unspecified number of users can access in advance.

### 5. Configuration of Terminal Device 300

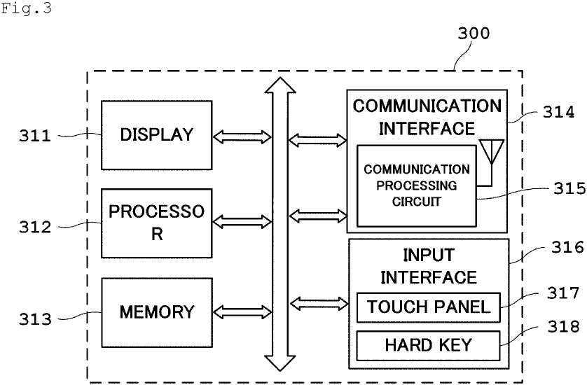

FIG. 3 is a block diagram illustrating an example of the configuration of the terminal device 300 according to the present disclosure. The terminal device 300 need not include all of the components illustrated in FIG. 3, and may have a configuration in which some of the components are omitted, or may additionally include other components.

As an example, the terminal device 300 may be a portable terminal device which is capable of wireless communication and is represented by a smartphone. However, in addition to the above, any device capable of executing the program according to the present disclosure, such as a feature phone, a portable information terminal, a PDA, a laptop personal computer, a desktop personal computer, a portable game machine, and a stationary game machine, may be suitably applied. In addition, when the program according to the present disclosure is executed by a plurality of terminal devices 300, the terminal devices 300 should not necessarily be the same or of the same type. For example, one terminal device 300 may be a smartphone and another terminal device 300 may be a laptop computer.

With reference to FIG. 3, the terminal device 300 includes a display 311, a processor 312, a memory 313 including a RAM, a ROM, or a nonvolatile memory (in some cases, an HDD), etc., a communication interface 314 including a communication processing circuit 315 and an antenna, and an input interface 316 including a touch panel 317 and a hard key 318. These components are electrically connected to one another via a control line and data lines.

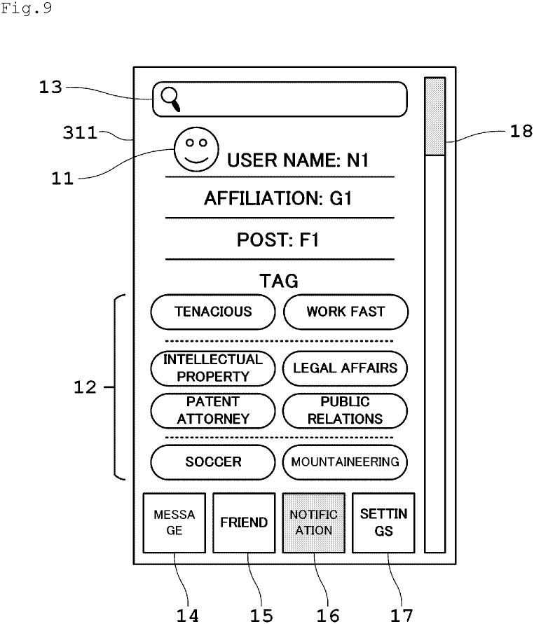

The display 311 functions as a display unit that performs various displays (for example, FIGS. 9 to 14, etc.) output by reading the image information stored in the memory 313 and executing the program according to the present disclosure in response to an instruction from the processor 312. The display 311 includes, for example, a liquid crystal display, an organic EL display, electronic paper, or the like.

The input interface 316 includes the touch panel 317 and/or the hard key 318, etc., and receives an instruction input by the user for execution of the program according to the present disclosure, that is, activation of an application, selection of recommended tag information, input of additional tag information, and the like. The touch panel 317 is disposed in such a manner as to cover the display 311 and outputs information of position coordinates corresponding to image data displayed on the display 311 to the processor 312. As a touch panel method, a known method such as a resistive-film based method, a capacitive-coupling based method, or a method using an ultrasonic surface acoustic wave may be used. According to the present disclosure, the touch panel 317 detects a swipe operation or a tap operation on each icon or the like displayed on the display 311 by an indicator. Although the input interface 316 included in the terminal device 300 is used according to the present disclosure, it is also possible to use the input interface 316, such as a mouse, which is connected to a main body including the processor 312 in a wireless or wired manner.

The processor 312 includes a CPU (microcomputer) and functions as a control unit that controls other connected components based on various programs stored in the memory 313. Specifically, the processor 312 reads a program for executing the application according to the present disclosure or a program for executing the OS according to the present disclosure from the memory 313 and executes the program. According to the present disclosure, processes such as the process of receiving tag information extracted in the server device 100 that has received source information in a free text related to a user owning the terminal device 300 from the information storage device 200 via the communication interface 314 as tag information that may be assigned to the user, the process of controlling to receive an instruction input by the user related to selection information indicating whether or not to select the received tag information via the input interface 316, the process of transmitting the received selection information to the server device 100 via the communication interface 314 are executed. The processor 312 may be comprised of a single CPU or may be comprised of a plurality of CPUs. In addition, other types of processors such as a GPU specifically designed for image processing may be appropriately combined.

The memory 313 includes a RAM, a ROM, a nonvolatile memory, an HDD, etc. and functions as a storage unit. The ROM stores an instruction command, as a program, for executing the application or the OS according to the present disclosure. The RAM is a memory used for writing and reading data while the program stored in the ROM is being processed by the processor 312. The nonvolatile memory is a memory to and from which data is written and read through the execution of the program, and the data written therein is still stored after the execution of the program ends. According to the present disclosure, the memory 313 particularly stores the program for processes such as the process of receiving tag information extracted in the server device 100 that has received source information in a free text related to a user owning the terminal device 300 from the information storage device 200 via the communication interface 314 as tag information that may be assigned to the user, the process of controlling to receive an instruction input by the user related to selection information indicating whether or not to select the received tag information via the input interface 316, the process of transmitting the received selection information to the server device 100 via the communication interface 314.

The communication interface 314 functions as a communication unit that transmits and receives information to and from the server device 100 or another terminal device installed at a remote place via the communication processing circuit 315 and the antenna. The communication processing circuit 315 performs a process for receiving a program, various kinds of information, and the like used in the system according to the present disclosure from the server device 100 in accordance with the progress of the process. According to the present disclosure, particularly, the selected tag information, the additional tag information, and the like are transmitted to the server device 100 and the recommended tag information and the like are received from the server device 100 via the communication interface 314.

The communication processing circuit 315 performs processing based on a broadband wireless communication method represented by the LTE method, and also may perform processing based on a method related to narrowband wireless communication such as a wireless LAN represented by IEEE802.11 or Bluetooth (registered trademark). Wired communication may also be used instead of or in addition to wireless communication.

### 6. Information Stored in Memory or the Like

FIG. 4A is a diagram conceptually illustrating the user information table stored in the server device 100 according to the present disclosure. As an example, the table stores information that is generated or input when each user installs and activates the program according to the present disclosure on the respective terminal device 300 owned by that user and performs user registration of the service related to the system 1. These pieces of information may be appropriately updated in accordance with an instruction input or the like from each user.

With reference to FIG. 4A, user name information, post information, affiliation information, tag information, and the like are stored in the user information table in association with user ID information. “User ID information” is unique information assigned to each user to specify each user. “User name information” is information related to the name or appellation of each user, and may be arbitrarily input by each user or may be acquired from another database (for example, a personnel database). “Post information” is information related to a role, a position, a title, and the like in an organization or the like to which each user currently belongs, and may be arbitrarily input by each user or may be acquired from another database (for example, a personnel database). “Affiliation information” is information indicating an organization to which each user belongs, or a department, a group, a team, or the like of the organization to which each user belongs, and may be arbitrarily input by each user or may be acquired from another database (for example, a personnel database). “Tag information” is information that is extracted from source information or may be stored according to an instruction input from another user, and is keyword information related to each user.

According to the present disclosure, tag information may be stored as it is input by the user himself or herself via the input interface 316. In addition, not all of the information specifically described in FIG. 4A needs to be stored, and some of the information may not be stored. In addition to the information specifically described in FIG. 4A, various kinds of information such as photo data, hometown information, qualification information, hobby information, and age information of each user may be stored in association with the user ID information of each user.

FIG. 4B is a diagram conceptually illustrating the personnel evaluation information table stored in the information storage device 200 according to the present disclosure. The personnel evaluation information table is illustrated as an example of a table in which information usable as source information is stored. With reference to FIG. 4B, the personnel evaluation information related to at least some of the users stored in the user information table illustrated in FIG. 4A is stored in the personnel evaluation information table. Specifically, the personnel evaluation information table stores time information, item A information, item B information, item C information, and the like in association with user ID information. “User ID information” is unique information assigned to each user to specify each user. “Time information” is information indicating a time at which the personnel evaluation information is input for each user. “Item A information”, “item B information”, and “item C information” are information indicating evaluation results that are actually input for the evaluation items A to C in the personnel evaluation. Specifically, the evaluation results are described in a free text form in association with the user ID information of each user, and are stored for each evaluation item.

FIG. 4C is a diagram conceptually illustrating the message information table stored in the information storage device 200 according to the present disclosure. The message information table is illustrated as an example of a table in which information usable as source information is stored. With reference to FIG. 4C, the message information table stores information on a message including at least some of the users stored in the user information table illustrated in FIG. 4A as senders or receivers. Specifically, the message information table stores channel information, time information, content information, sender information, receiver information, and the like in association with message ID information. “Message ID information” is unique information assigned to each message to specify that message. “Channel information” is information for specifying a virtual location or group for sharing various kinds of information such as the message, a tool, or a file with one user or among a plurality of users. Users who can access each channel are managed by a separately provided channel information table (not illustrated). “Time information” is information indicating a time at which each message is transmitted or received for each message. “Content” information is information indicating the specific content of each message, and includes information such as a sentence or dialogue written in a free text form, and a subject. “Sender information” is information for specifying a user who has sent a message in a channel associated with each message. “Receiver information” is information for specifying at least one user in a channel associated with each message as a receiver.

FIG. 4D is a diagram conceptually illustrating the candidate tag information table stored in the server device 100 according to the present disclosure. The information stored in the tag information table may be input in advance by an operator or the like of the system 1 according to the present disclosure, or may be input by receiving an instruction input from each user on each terminal device.

With reference to FIG. 4D, the candidate tag information table includes a plurality of pieces of tag information that can be recommended as the tag information stored in the user information table of each user. As an example, these pieces of tag information may include one word or a combination of a plurality of words, such as “intellectual property” and “like sweets”, or may include a plurality of words in a sentence form, such as “strong in patents”. The tag information table is used when tag information to be recommended to a specific user is extracted from source information which is in a free text form and stored in FIG. 4B or FIG. 4C.

According to the present disclosure, category information (for example, “work”, “hobby”, “personality”, or the like) to which each piece of tag information belongs may be stored in association with each piece of tag information. With such category information being stored, for example, when a tag is displayed in the profile information of each user, it is possible to perform collective management such as displaying the tag information by category or collectively adding or deleting tag information included in a certain category.

According to the present disclosure, the process of extracting tag information from source information is performed in order to automatically extract the tag information that can be assigned to each user. As the source information, the personnel evaluation information and the message information exemplified in FIGS. 4B and 4C are used. FIG. 4E is a diagram conceptually illustrating the personnel evaluation information stored in the information storage device 200 according to the present disclosure. Specifically, FIG. 4E illustrates an example of item A information (information of change action or decision making) and item B information (job execution degree) among the actual personnel evaluation information in which the user ID information stored in the personnel evaluation information table of FIG. 4B is stored in association with the user of U1. With reference to FIG. 4E, as the information of change action or decision making, an evaluator (for example, a supervisor of the organization to which the user belongs) for the user with the user ID information “U1” uses a terminal device owned by the evaluator to input the evaluation that “N1 took advantage of his own strength in patents and implemented new initiatives, including the creation of an internal process for patents. This has enabled us to streamline our operations and improve our business performance.” and the evaluation is stored subsequently in the memory 313. Similarly, as the job execution degree, the evaluation that “N1 created a business process for each case and steadily produced results according to the process. Therefore, N1 was able to maximize the results in a minimum period of time. In addition, N1 showed his sense of responsibility to the fullest, just as other persons in charge dealt tenaciously with complex cases.” is input and stored in the memory 313.

As is apparent from FIG. 4E, the information used as source information is information described in a free text form for the main purpose of personnel evaluation, and is not information input in an expression form optimized for tag extraction for the main purpose of tag extraction. That is, the information input in a free text form composed of a plurality of words is used as source information.

Although not particularly illustrated, the content information included in the message information table of FIG. 4C is also information described in a free text form for the main purpose of message transmission as in FIG. 4E, and is not input in an expression form optimized for tag extraction. For example, information entered in a free text form, such as a conversation or a sentence like “Thank you, N1, for your advice on the patent case the other day. I fully understand that N1 is strong in patents.” is used as source information.

### 7. Processing Sequence Executed in System 1

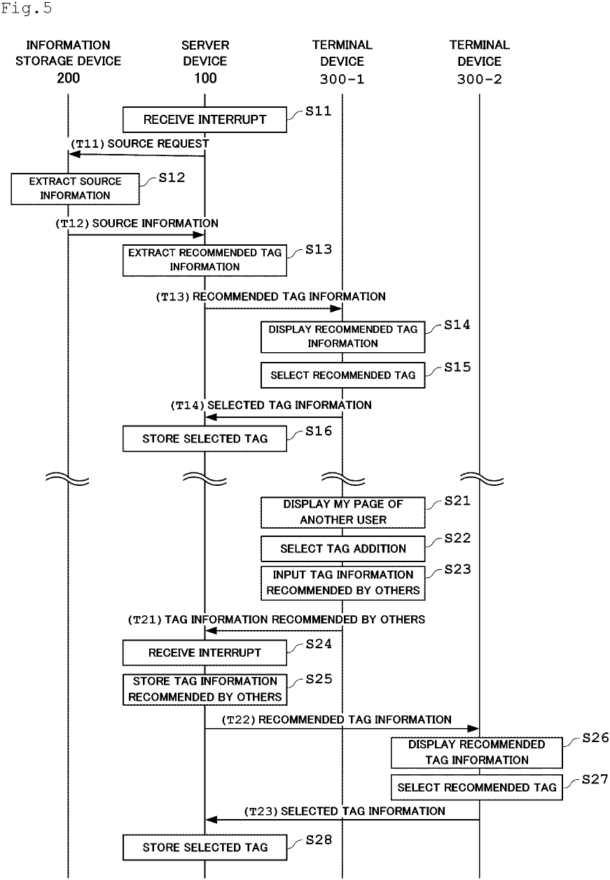

FIG. 5 is a diagram illustrating the processing sequence executed in the system 1 according to the present disclosure. Specifically, FIG. 5 is a diagram illustrating a processing sequence (first half) in a case where tag information is automatically extracted from source information and a processing sequence (second half) in a case where tag information is generated by recommendation from other users among processing sequences of various processes executed among the server device 100, the information storage device 200, and the terminal device 300 (terminal device 300-1 and terminal device 300-2).

First, in FIG. 5, a processing sequence (first half) in the case where tag information is automatically extracted from source information will be described. With reference to FIG. 5, the processing sequence is started by receiving a tag update interrupt for updating tag information in the server device 100 (S11). The tag update interrupt is a signal periodically transmitted using a timer or the like, and is a signal that serves as a trigger for referring to time information of the personnel evaluation information table or the message information table of the information storage device 200 and receiving information which has been updated since the reception of the previous interrupt upon receiving the interrupt. Therefore, the server device 100 transmits a source request (S11) for requesting transmission of source information to the information storage device 200 together with the user ID information of each user. The information storage device 200 that has received the source request refers to the personnel evaluation information table to check whether or not there is information that has been updated during the period from the reception of the previous source request to the present for each piece of received user ID information. When there is updated information, the information storage device 200 extracts the personnel evaluation information (item A information or the like) associated with the user ID information as source information (S12). Similarly, the information storage device 200 refers to the message information table to check whether or not there is information that has been updated during the period from the reception of the previous source request to the present among the messages in which the received user ID information is included in the sender information or the receiver information. When there is updated information, the information storage device 200 extracts the content information of the message as source information. The information storage device 200 transmits each piece of extracted source information (T12) to the server device 100 in association with the user ID information.

The server device 100 that has received the source information performs a process of extracting tag information that may be assigned to the user associated with the user ID information received together with the source information as recommended tag information from the received source information (S13). Then, the server device 100 stores the extracted recommended tag information (T13) in the user information table in association with the user ID information, and transmits the extracted recommended tag information to the terminal device 300-1 owned by the user with the user ID information.

The terminal device 300-1 that has received the recommended tag information (T13) displays the received recommended tag information on the display 311 (S14), and receives a selection by the user of the terminal device 300-1 via the input interface 316 (S15). The terminal device 300-1 transmits the tag information selected from the recommended tag information as selected tag information (T14) to the server device 100 together with the user ID information. The server device 100 that has received the selected tag information refers to the user information table and stores the received selected tag information in tag information as additional tag information in association with the received user ID information (S16). Thus, the newly stored tag information is newly assigned as tag information related to the user associated with the user ID information. Then, a series of processing sequences is ended.

Each piece of tag information added to the user information table in this way may be referred to as tag information, when My Page or the like of each user is displayed, or can be used as a keyword, when searching for another user, in the application according to the present disclosure.

Next, a processing sequence (latter half) in FIG. 5 in a case where tag information is generated by recommendation from other users will be described. With reference to FIG. 5, in the processing sequence, in response to an instruction input of the user of the terminal device 300-1, the terminal device 300-1 displays My Page of another user (for example, a user owning the terminal device 300-2) on the display 311 (S21). The terminal device 300-1 receives the instruction input of the user via the input interface 316, and selects a “tag addition” icon (S22). The terminal device 300-1 receives, via the input interface 316, input of tag information to be assigned to the user who carries the terminal device 300-2 (S23). Then, the terminal device 300-1 transmits the received tag information as tag information recommended by others (T21) to the server device 100 together with the user ID information of the user of the terminal device 300-2.

When the server device 100 receives the tag update interrupt generated by receiving the tag information recommended by others (T21) from the terminal device 300-1 (S24), the server device 100 stores the received tag information recommended by others in the user information table together with the user ID information of the user owning the terminal device 300-2 received together (S25). Then, the server device 100 transmits the stored tag information recommended by others to the terminal device 300-2 as recommended tag information together with the associated user ID information.

The processes (S26 to S28) performed after the terminal device 300-2 receives the recommended tag information are the same as the processes of S14 to S16 performed in the first half. Each piece of tag information added to the user information table in this way may be referred to as tag information, when My Page or the like of each user is displayed, or can be used as a keyword, when searching for another user, in the application according to the present disclosure.

FIG. 5 illustrates a case where the selection processes, etc. (S14 and S15) for the tag information automatically extracted from the source information are performed in the terminal device 300-1, and the same processes may be performed in the terminal device 300-2. In addition, FIG. 5 illustrates a case where the processes, etc. (S21 to S23) of inputting tag information to be recommended to other users are performed in the terminal device 300-1, and the same processes may be performed in the terminal device 300-2. Further, FIG. 5 illustrates the case where the selection processes, etc. (S26 and S27) for the tag information recommended by other users are performed in the terminal device 300-2, and the same processes may be performed in the terminal device 300-1.

### 8. Processing Flow Executed in Server Device 100

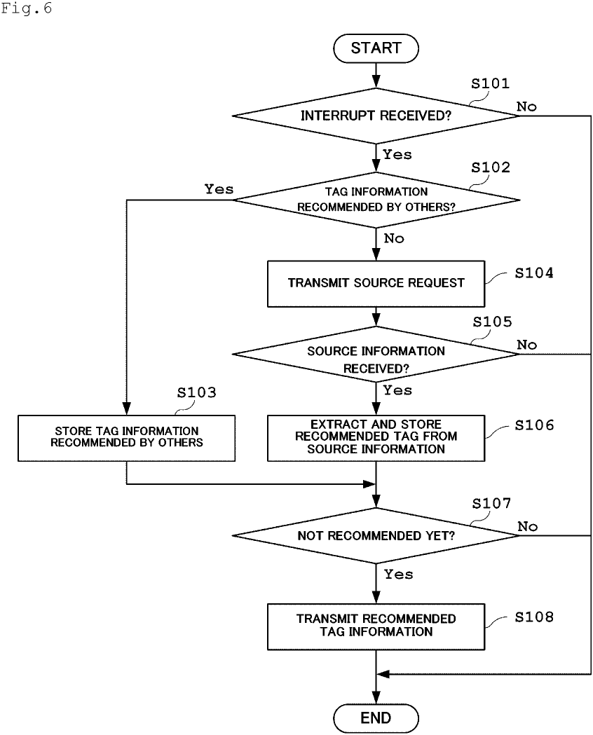

FIG. 6 is a diagram illustrating the processing flow executed in the server device 100 according to the present disclosure. Specifically, this is a processing flow performed by the server device 100 in S11 and S13, and S24 and S25, among the processing sequences of FIG. 5. The processor 112 of the server device 100 reads and executes a program stored in the memory 111 to perform the processing flow.

With reference to FIG. 6, the processing flow is started when the processor 112 receives an interrupt signal (S101). Upon receiving the interrupt signal, the processor 112 determines whether or not the received interrupt signal is generated by receiving the tag information recommended by others (T21) illustrated in FIG. 5 (S102). When the received interrupt signal is generated by receiving the tag information recommended by others, the processor 112 performs control so that the received tag information recommended by others is stored in the user information table of the memory 111 in association with the user ID information received together (S103).

On the other hand, when the received interrupt signal is not generated by receiving the tag information recommended by others, the interrupt signal serves as a trigger for referring to time information of the personnel evaluation information table or the message information table of the information storage device 200 and receiving information which has been updated since the reception of the previous interrupt. Therefore, the processor 112 controls the communication interface 114 to transmit the source request together with each piece of user ID information stored in the user information table to the information storage device 200 (S104).

Thereafter, the processor 112 determines whether or not information (information of items A to C of the personnel evaluation information table and content information of the message information table) updated during the period from the transmission of the previous source request to the present has been received as source information from the information storage device 200 together with the user ID information associated with each piece of information (S105). Then, when the information has been received, the processor 112 extracts tag information that may be assigned to the user from each piece of the received source information, and stores the tag information in the user information table in association with each piece of the user ID information (S106) .

Here, the process of extracting from the received source information is executed by a method using the candidate tag information table illustrated in FIG. 4D as an example. Specifically, the processor 112 compares the received source information with the candidate tag information stored in the memory 111 to check whether or not there is a phrase matching the candidate tag information in the source information. When there is a matching phrase, the matching phrase is extracted as tag information that may be assigned to the user. To further describe the case of the personnel evaluation information described in the free text form illustrated in FIG. 4E, the processor 112 compares the input text data with the candidate tag information of FIG. 4D. Then, the processor 112 extracts the phrases “strong in patents”, “maximize”, “tenacious”, and “sense of responsibility” from the personnel evaluation information of FIG. 4E as the phrases matching the candidate tag information of FIG. 4D.

Further, the process of extracting from the received source information may be performed by combining a method using the candidate tag information table illustrated in FIG. 4D with a method such as morphological analysis. Here, the morphological analysis is an analysis process in which text data or the like described in a free text form is divided into strings of morphemes, i.e., the smallest units of phrase and the part of speech, etc. of each of the divided morphemes are determined based on dictionary data in which words and their parts of speech, etc. are stored in advance. The use of the morphological analysis makes it unnecessary to previously assign a grammatical meaning to each morpheme constituting the text data described in the free text form.

To give a description based on the example of the personnel evaluation information of FIG. 4E, the processor 112 performs a morphological analysis on the personnel evaluation information of FIG. 4E, thereby making it possible to specify the subject of each piece of extracted tag information. For example, by the morphological analysis, the processor 112 specifies “N1” as a subject corresponding to “strong in patents”, “maximize”, and “sense of responsibility”, and specifies “another person in charge” as a subject corresponding to “tenacious”. In this way, by combining with the morphological analysis, the processor 112 can extract tag information corresponding to only a specific user name.

Further, the extracted tag information can be weighted by a category associated with the extracted tag information in the candidate tag information table, a subject obtained based on the morphological analysis, a frequency described in the source information, time information associated with each piece of source information, and the like. Specifically, a weighting table is prepared in advance, and a weighting coefficient is stored in association with each category, each subject, each frequency, and each piece of time information. Then, when tag information is extracted from source information, the processor 112 arranges the extracted tag information in descending order of a value obtained by multiplying the tag information by the specified weighting coefficient (that is, in descending order of importance), and stores only tag information within a predetermined rank as recommended tag information in association with the user ID information.

When the recommended tag information is extracted in this way, the processor 112 determines whether or not the recommended tag information matches the tag information recommended in the past in combination with the tag information recommended by others and stored via S103 (S107). Specifically, tag information recommended in the past is stored in advance in the user information table in association with each piece of user ID information, and the processor 112 makes a determination with reference to the information. Then, the processor 112 transmits only tag information that does not match the tag information recommended in the past to the terminal device 300 owned by the user associated with each piece of user ID information (S108).

The above completes the series of processes until tag information that may be assigned to each user is extracted and transmitted as recommended tag information. Note that the recommended tag extraction method in FIG. 6 is merely an example. For example, a named entity extraction method may be used instead of or in combination with the method of FIG. 6. In the named entity extraction method, various expression forms peculiar to an organization, such as person’s name, place name, organization name, date, quantity, amount of money, etc. are defined in advance, and the information which is peculiar to the organization and matches the definition is extracted from received source information which is in a free text form. For example, in a case where there is a post named “risk management” in a certain organization, although only “management” is extracted in the method of FIG. 6, it is possible to extract the correct position information of “risk management” by using the named entity extraction method. Thus, the method described in FIG. 6 is an example, and may be used in place of or in combination with other methods such as the named entity extraction method.

### 9. Processing Flow Executed in Terminal Device 300

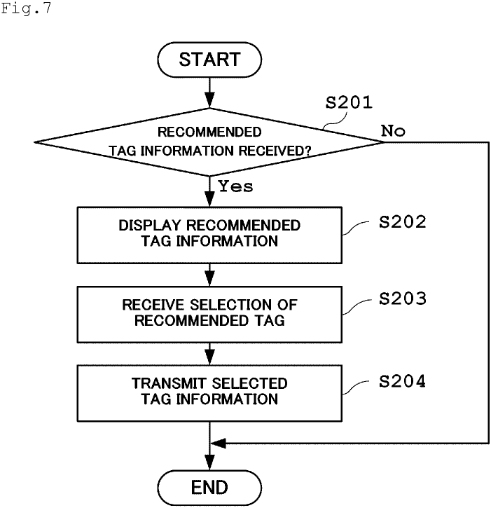

FIG. 7 is a diagram illustrating the processing flow executed in the terminal device 300 according to the present disclosure. Specifically, this is a processing flow performed by the terminal device 300 in S14 and S15, and S26 and S27, among the processing sequences of FIG. 5. The processor 312 of the terminal device 300 reads and executes a program stored in the memory 313 to perform the processing flow.

With reference to FIG. 7, the processing flow starts when the terminal device 300 receives the recommended tag information from the server device 100 via the communication interface 314 (S201). Upon receiving the recommended tag information, the processor 312 controls the display 311 to display the recommended tag information. Then, the processor 312 receives an instruction input by the user owning the terminal device 300 via the input interface 316, and generates selected tag information indicating whether or not to select addition of the displayed recommended tag information as the own tag information (S203). Then, the processor 312 controls the communication interface 314 so that the selected tag information including the tag information selected to be added is transmitted to the server device 100 together with the user ID information of the user owning the terminal device 300 (S204).

The above completes a series of processes related to the selection of whether or not to add the recommended tag information transmitted to the terminal device 300.

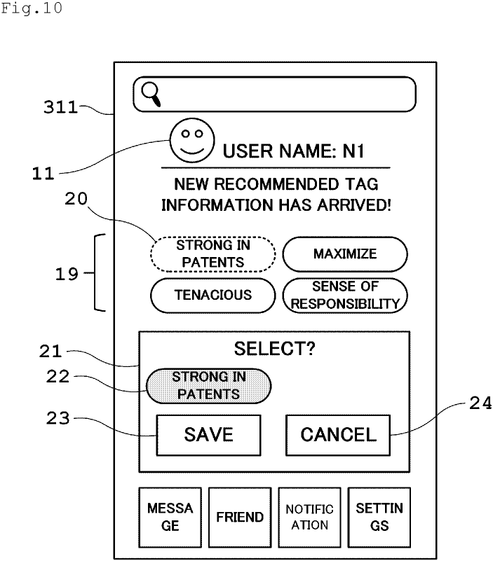

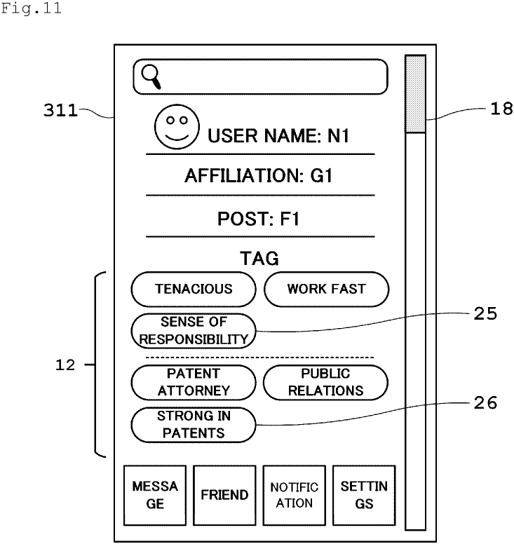

Here, FIGS. 9, 10, and 11 are diagrams illustrating examples of screens displayed on the terminal device 300 according to the present disclosure. Specifically, FIG. 9 illustrates an example of a screen displayed when recommended tag information is received in S201 of FIG. 7, FIG. 10 illustrates an example of a screen displayed when recommended tag information is displayed and selection is received in S202 and S203 of FIG. 7, and FIG. 11 illustrates an example of a screen displayed after selected tag information is transmitted.

FIG. 9 illustrates an example of a screen of My Page displayed when the program used in the system 1 according to the present disclosure is activated in the terminal device 300. Specifically, FIG. 9 illustrates an example of a screen of My Page of a user whose user ID information is U1 and who is the user of the terminal device 300-1. With reference to FIG. 9, the image data, the user name information, the affiliation information, and the post information stored in association with the user ID information (U1) are displayed in a user information display area 11 at an upper portion of the display 311 of the terminal device 300-1. In addition, the tag information stored in association with the user ID information is displayed in a tag information display area 12 below the user information display area 11. In the example of FIG. 9, the tag information items such as “tenacious”, “intellectual property”, and “soccer” are displayed separately by category associated with each piece of tag information. Further, an icon for shifting to another function executable by the program is displayed at a bottom portion of the display 311. For example, when the user inputs an instruction at a coordinate position corresponding to a message icon 14, the screen shifts to a message transmission screen. When the user inputs an instruction at a coordinate position corresponding to a friend icon 15, the screen shifts to a friend selection screen to make it possible to display My page or the like of another user who is a friend. When the user inputs an instruction at a coordinate position corresponding to a notification icon 16, the screen shifts to a display screen of various notification information received from the server device 100. When the user inputs an instruction at a coordinate position corresponding to a setting icon 17, the screen shifts to a setting screen for changing the profile information of the user or changing the initial setting items of the program.

Here, as described above, FIG. 9 illustrates an example of a screen displayed when the recommended tag information is received in S201 of FIG. 7. Therefore, in order to visibly notify the user that the recommended tag information has been received from the server device 100, the display mode of the notification icon 16 is changed and displayed. At this time, when the user inputs an instruction via the input interface 316 at the coordinate position corresponding to the notification icon 16, the screen shifts to the screen illustrated in FIG. 10.

FIG. 10 illustrates an example of a selection screen for displaying recommended tag information and receiving selection. With reference to FIG. 10, the image data and the user name information stored in association with the user ID information (U1) are displayed at an upper portion of the display 311 of the terminal device 300-1, and the notification “new recommended tag information has arrived!” which is the content of the notification this time is displayed below the image data and the user name information. In addition, below the notification, the actually received recommended tag information (“strong in patents”, “maximize”, “persistent”, and “sense of responsibility”) is displayed in a recommended tag display area 19. Further, a tag information selection area 21 is displayed below the recommended tag display area 19. Receiving an instruction input by the user via the input interface 316 and moving it from among the recommended tag information displayed in the recommended tag display area 19 to the tag information selection area 21 makes it possible to select tag information that the user wants to store as his or her own tag information. In the example of FIG. 10, the recommended tag information displayed in the recommended tag display area 19 is moved to the tag information selection area 21 via the input interface 316 by a drag-and-paste operation. Thus, the display of the recommended tag information is erased at a position 20 at which the recommended tag information is originally displayed, and the display mode is changed and the recommended tag information is displayed at a position 22 to which the recommended tag information is moved. The tag information selection area 21 also includes a save icon 23 and a cancel icon 24. When the user inputs an instruction at a coordinate position corresponding to the save icon 23, the recommended tag information moved to the tag information selection area 21 is determined as the selected tag information and transmitted to the server device 100. Thus, the transmitted selected tag information is assigned as the tag information of the user. On the other hand, when the user inputs an instruction at a coordinate position corresponding to the cancel icon 24, the recommended tag information once moved to the tag information selection area 21 is erased from the tag information selection area 21 and is displayed again in the recommended tag display area 19.

FIG. 11 illustrates an example of a screen of My Page displayed when the program used in the system 1 according to the present disclosure is activated in the terminal device 300 after the selected tag information is transmitted. With reference to FIG. 11, various pieces of user information associated with the user ID information (U1) are displayed as in FIG. 9, and tag information 25 and 26, and the like corresponding to the selected tag information which is selected by the user are additionally displayed in the tag information display area 12. This is because the selected tag information is stored in the user information table of the server device 100 in association with the user ID information by selecting each piece of recommended tag information on the screen of FIG. 10. When the tag information displayed in the tag information display area 12 is increased and cannot be displayed in one screen, it is possible to display the tag information by moving a scroll bar 18 to move the screen.

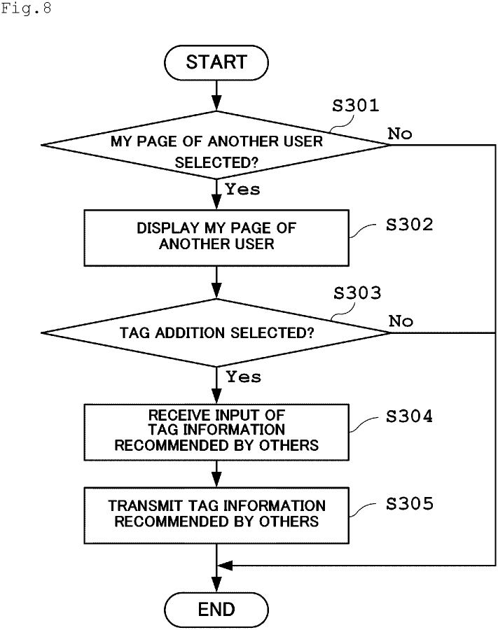

FIG. 8 is a diagram illustrating the processing flow executed in the terminal device 300 according to the present disclosure. Specifically, this is a processing flow performed by the terminal device 300 in S21 to S23, among the processing sequences of FIG. 5. The processor 312 of the terminal device 300 reads and executes a program stored in the memory 313 to perform the processing flow.

With reference to FIG. 8, when an instruction input by the user of the terminal device 300 is received via the input interface 316 of the terminal device 300 to select to display My Page of another user, the processing flow starts (S301). When the display of My Page of another user is selected, the processor 312 controls the display 311 to display the My Page screen of the another user (S302). Then, the processor 312 determines whether or not the “tag addition” icon is selected through the input interface 316 on the My Page screen of the another user (S303). When the tag addition icon is selected, the processor 312 receives input of tag information recommended by others on the another user via the input interface 316, and stores the received tag information recommended by others in the memory 313 in association with the user ID concession of the another user. Then, the processor 312 performs control so that the stored tag information recommended by others is transmitted to the server device 100 via the communication interface 314 (S305).

The above completes a series of processes related to the recommendation by others of the tag information of the another user.

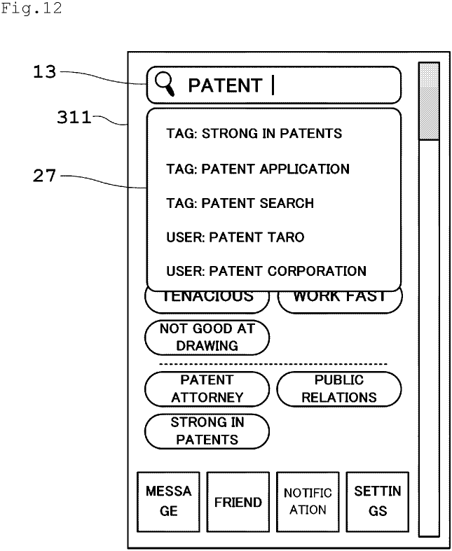

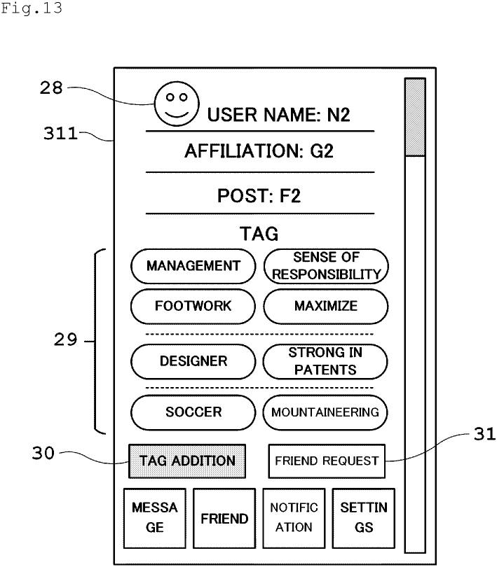

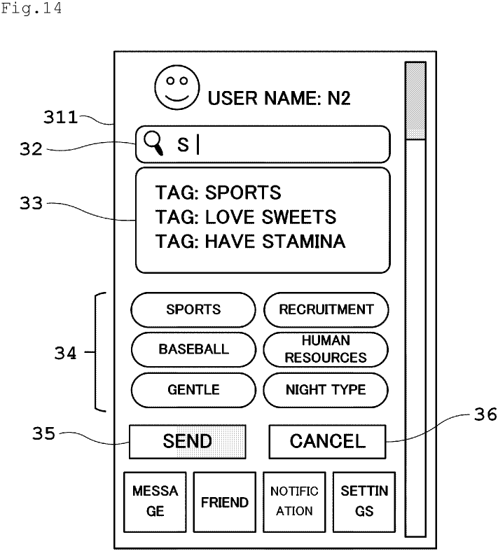

Here, FIGS. 12, 13, and 14 are diagrams illustrating examples of screens displayed on the terminal device 300 according to the present disclosure. Specifically, FIG. 12 illustrates an example of a screen displayed when My Page of another user is selected in S301 of FIG. 8, FIG. 13 illustrates an example of the My Page screen of the another user displayed in S302 of FIG. 7, and FIG. 14 illustrates an example of a screen displayed when input of tag information recommended by others is received in S304 of FIG. 7.

With reference to FIG. 12, the My Page screen of the user (user identification information (U1)) of the terminal device 300-1 is displayed. In an upper portion of the My Page screen, a search bar 13 for searching for My Page screens of other users is displayed. Then, by receiving an instruction input by the user via the input interface 316, specifically, by tapping the search bar 13 and then receiving an input operation of characters “patent” in the search bar 13, the search candidates are displayed in a search candidate display area 27. Specifically, in the search candidate display area 27, tag information including the input character string “patent” (“strong in patents”, “patent application”, “patent search”) and user name information (“Patent Taro”, “Patent Corporation”) are displayed. Then, by receiving selection of a desired search candidate by the user via the input interface 316, a search request for the user information table is made to the server device 100 using the selected search candidate (for example, the tag “strong in patents”) as a search key.

FIG. 13 illustrates an example in which a user name N2 is selected as another user from the result of searching the user information table using the search candidate selected as the search key on the screen illustrated in FIG. 12 and My Page of the user is displayed on the display 311 of the terminal device 300-1. With reference to FIG. 13, the image data, the user name information, the affiliation information, and the post information stored in association with the user ID information (U2) are displayed in a user information display area 20 at an upper portion of the display 311 of the terminal device 300-1. In addition, the tag information stored in association with the user ID information is displayed in a tag information display area 29 below the user information display area 20. In the example of FIG. 13, the tag information “strong in patents” used as the search key and the tag information such as “management”, “designer”, and “soccer” is displayed separately by category associated with each piece of tag information. A tag addition icon 30 for the user (user ID information (U1)) of the terminal device 300-1 to recommend the tag information to the another user (user ID information (U2)) is displayed below the tag information display area 29. When the user inputs an instruction at a coordinate position corresponding to the tag addition icon 30, the screen shifts to the screen of FIG. 14 which is displayed when the input of the tag information recommended by others is received. A friend request icon 31 is displayed next to the tag addition icon 30. When the user inputs an instruction at a coordinate position corresponding to the friend request icon 31, a friend request can be made to another user, and when the request is accepted, detailed user information of the another user can be accessed. The friend request icon should not necessarily be provided. According to the present disclosure, as an example, the information storage device 200 to which access by an unspecified number of users is restricted is used, and information or the like stored in the information storage device 200 is used among users belonging to the same organization. For this reason, it is not always necessary to make a friend request or the like each time, and it may be possible to browse all of information of another user who has been searched for, or as much of the information as possible.

FIG. 14 illustrates an example of an input screen of tag information recommended by others which is shifted by receiving an instruction input to the tag addition icon 30 via the screen illustrated in FIG. 13. With reference to FIG. 14, a search box 32 is displayed, and by receiving an instruction input to the search box 32 via the input interface 316, that is, receiving a character input of “s” after tapping the search box 32, the search candidates are displayed in a search candidate display area 33. Specifically, in the search candidate display area 33, pieces of tag information including “s” as options of tag information recommended by others are respectively displayed, and by receiving selection of tag information including any one of them, tag information is selected as the tag information recommended by others. Each piece of the selected tag information recommended by others is displayed in a tag-information-recommended-by-others display area 34. A send icon 35 and a cancel icon 36 are displayed respectively below the tag-information-recommended-by-others display area 34. When the user inputs an instruction at a coordinate position corresponding to the send icon 35, the tag information displayed in the tag-information-recommended-by-others display area 34 is transmitted to the server device 100 as the tag information recommended by others. When the user inputs an instruction at a coordinate position corresponding to the cancel icon 36, the tag information displayed in the tag-information-recommended-by-others display area 34 is entirely erased.

As described above, according to the present disclosure, tag information assigned as information related to each user can be stored as profile information of each user. In addition, in the system according to the present disclosure makes it possible to reflect evaluation of the user himself or herself from other users as tag information by automatically extracting such tag information from various source information associated with each user (for example, information in a free text form such as personnel evaluation information of each user and message information transmitted and received by each user). For example, more specific and highly confidential tag information can be assigned to each user by using source information, etc. that can be accessed only within an organization to which each user belongs instead of source information that can be easily accessed by an unspecified number of users.

The processes and procedures described herein may be achieved not only by those explicitly described in the embodiments but also by software, hardware, or a combination thereof. Specifically, the processes and procedures described herein are achieved by implementing logic corresponding to the processes in a medium such as an integrated circuit, a volatile memory, a nonvolatile memory, a magnetic disk, or an optical storage. The processes and procedures described herein may be implemented as computer programs and executed by various computers including a terminal device and a server device.

Although the processes and procedures described herein are described as being executed by a single device, software, component, or module, such processes or procedures may be executed by a plurality of devices, a plurality of sorts of software, a plurality of components, and/or a plurality of modules. In addition, although it is described that various kinds of information described herein are stored in a single memory or storage unit, such information may be distributed and stored in a plurality of memories provided in a single device, or in a plurality of memories distributed and arranged in a plurality of devices. Furthermore, the software and hardware elements described herein may be achieved by integrating them into fewer components or dividing them into more components.

1. A server device comprising:
a communication interface configured to transmit and receive predetermined information to and from one or more information storage devices and a plurality of terminal devices including a first terminal device via a network;
a memory configured to store the computer readable instructions and tag information assigned to a first user in association with user ID information of the first user owning the first terminal device; and
a processor configured to execute the computer readable instruction stored in the memory, so as to:
receive, via the communication interface, source information in a free text related to the first user from at least one among the one or more information storage devices,
extract tag information which may be assigned to the first user from the received source information, and
enable the extracted tag information to be associated with the identification information of the first user and to be stored in the memory.

2. The server device according to claim 1, wherein
at least one of the one or more information storage devices are an information storage device restricted from accessing from an unspecified number of users.

3. The server device according to claim 1, wherein
at least one of the one or more information storage devices are an information storage device restricted from accessing from a user other than users belonging to an organization the first user belongs.

4. The server device according to claim 1, wherein
the source information is information restricted from browsing a user other than users belonging to an organization the first user belongs.

5. The server device according to claim 1, wherein
the source information includes personnel evaluation information assigned to the first user in an organization the first user belongs.

6. The server device according to claim 1, wherein
the source information includes message information transmitted or received between the first terminal device owned by the first user and a second terminal device owned by a second user different from the first user.

7. The server device according to claim 1, wherein
the extracted tag information is transmitted to the first terminal device as recommended tag information.

8. The server device according to claim 7, wherein
the tag information transmitted to the first terminal device is stored in the memory in association with the identification information of the first user in response to reception of selection by the first user of the first terminal device.

9. The server device according to claim 1, wherein
the tag information which is enabled to be stored in the memory includes tag information input by a second user different from the first user in addition to tag information extracted from the source information.

10. The server device according to claim 1, wherein
the memory is configured to store a plurality of pieces of candidate tag information be candidates for tag information to be extracted, and
the extraction is performed by comparing the plurality of pieces of candidate tag information stored in the memory with the source information.

11. The server device according to claim 1, wherein
the extraction is performed by conducting a morphological analysis on the source information.

12. The server device according to claim 11, wherein
the processor is configured to perform weighting based on the morphological analysis on extracted tag information.

13. A computer program product embodying computer readable instructions stored on a non-transitory computer-readable storage medium for causing a computer to execute a process by a processor, the computer including a communication interface configured to transmit and receive predetermined information to and from one or more information storage devices and a plurality of terminal devices including a first terminal device via a network, and a memory configured to store tag information assigned to a first user in association with user ID information of the first user owning the first terminal device to execute a process by a processor so as to perform the steps of:
receiving, via the communication interface, source information in a free text related to the first user from at least one among the one or more information storage devices;
extracting tag information which may be assigned to the first user from the received source information; and
enabling the extracted tag information to be associated with the identification information of the first user and to be stored in the memory.

14. A method performed for causing a processor in a computer to execute a process, the computer including a communication interface configured to transmit and receive predetermined information to and from one or more information storage devices and a plurality of terminal devices including a first terminal device via a network, and a memory configured to store computer readable instructions and tag information assigned to a first user in association with user ID information of the first user owning the first terminal device, the method comprising executing on the processor the computer readable instructions comprising the steps of:
receiving, via the communication interface, source information in a free text related to the first user, from at least one among the one or more information storage devices;
extracting tag information which may be assigned to the first user from the received source information; and
enabling the extracted tag information to be associated with the identification information of the first user and to be stored in the memory.

15. A terminal device comprising:
a communication interface configured to transmit and receive predetermined information via a network to and from a server device communicably connected to one or more information storage devices;
a memory configured to store computer readable instructions and tag information assigned to a user in association with identification information of the user;
an input interface configured to receive an instruction input from the user; and
a processor configured to execute the computer readable instructions so as to:
receive, via the communication interface, tag information extracted in the server device which has received source information in a free text related to the user from at least one among the one or more information storage devices as tag information that may be assigned to the user, and
store the received tag information in the memory.
